(19) United States
(12) Patent Application Publication
(10) Pub. No.: US 2023/0331202 A1
(43) Pub. Date: Oct. 19, 2023

(54) BRAKE SYSTEM

(71) Applicant: TOYOTA JIDOSHA KABUSHIKI KAISHA, Toyota-shi (JP)

(72) Inventors: Fumiaki Saito, Susono-shi (JP); Hiroaki Endo, Susono-shi (JP); Shimpei Kodani, Okazaki-shi (JP)

(73) Assignee: TOYOTA JIDOSHA KABUSHIKI KAISHA, Toyota-shi (JP)

(21) Appl. No.: 18/296,658

(22) Filed: Apr. 6, 2023

(30) Foreign Application Priority Data
Apr. 14, 2022 (JP) 2022-066959

(51) Int. Cl. B60T 8/1761; B60T 8/1763; B60T 13/66

(52) U.S. Cl. CPC B60T 8/17616; B60T 8/17636; B60T 13/662; B60T 1/065; B60T 2210/10; B60T 2270/10

(57) ABSTRACT

A vehicle brake system includes: a brake device configured to apply a braking force to a wheel; and a controller configured to cause the brake device to perform an ABS operation when a slip ratio of the wheel exceeds a threshold. The ABS operation includes a decrease mode in which the braking force is decreased and an increase mode in which the braking force is increased to restore the braking force after the decrease mode. The controller determines a final target braking force that should be attained at an end time point of the ABS operation based on the braking force at a start time point of the ABS operation and determines a cycle time of the ABS operation based on a condition of a road surface on which the vehicle travels. The cycle time is a length of time in which the ABS operation is performed.

### REFERENCE TO RELATED APPLICATIONS

The present application claims priority to Japanese Patent Application No. 2022-066949 filed on Apr. 14, 2022. The entire content of the priority application is incorporated herein by reference.

### BACKGROUND ART

The following disclosure relates to a brake system configured to perform an ABS operation.

A brake system typically performs an ABS (antilock or antiskid) control to prevent locking of a wheel. In the ABS control, a brake device performs an ABS operation including a pressure decrease mode and a pressure increase mode when a slip ratio of the wheel exceeds a set slip ratio. Various techniques relating to the ABS control have been developed. For instance, Japanese Patent Application Publication No. 2008-110716, which discloses a hydraulic brake system, describes a technique in which, when one of right and left wheels is in the pressure decrease mode, a pressure increase gradient in the pressure increase mode of the other of the right and left wheels is adjusted.

### SUMMARY

In the technique described above, the pressure increase gradient is kept constant. Keeping the pressure increase gradient constant, however, does not necessarily result in an appropriate ABS operation depending upon a friction coefficient of a road surface. For an appropriate ABS operation, it is desirable to consider many factors such as the weight of an own vehicle and a traveling situation including the friction coefficient of the road surface. The increase of the factors leads to an increase of arithmetic processing executed by a controller for the ABS operation, thus causing an excessive load on the brake system. Thus, there remains much room for improvement in the ABS control. The utility of the brake system that performs the ABS operation is enhanced by making some modifications. Accordingly, an aspect of the present disclosure relates to a brake system with high utility.

In one aspect of the present disclosure, a brake system for a vehicle includes: a brake device configured to apply a braking force to a wheel; and a controller configured to cause the brake device to perform an ABS operation when a slip ratio of the wheel exceeds a threshold, the ABS operation including, each as an operation mode, a decrease mode in which the braking force is decreased and an increase mode in which the braking force is increased to restore the braking force after the decrease mode, wherein the controller determines a final target braking force that should be attained at an end time point of the ABS operation based on the braking force at a start time point of the ABS operation and determines a cycle time of the ABS operation based on a condition of a road surface on which the vehicle travels, the cycle time being a length of time in which the ABS operation is performed.

In the brake system according to the present disclosure, the controller determines the final target braking force based on the braking force at the start time point of the ABS operation and determines the cycle time, namely, the length of time from the start time point to an end time point of one ABS operation, based on the condition of the road surface on which the vehicle travels. This configuration achieves an appropriate ABS operation by a relatively simple process without involving any complicated process such as determination of the increase gradient of the braking force in the increase mode based on other factors such as the weight of the vehicle.

### VARIOUS FORMS

The brake system according to the present disclosure may employ, as the brake device, a hydraulic brake device including a rotary member configured to rotate with the wheel, a friction member configured to be pressed against the rotary member, a hydraulic cylinder configured to be operated to press the friction member against the rotary member, and a working-fluid supply device configured to supply a working fluid to the hydraulic cylinder. The brake device employed in the present brake system is not limited to the hydraulic brake device but may be an electric brake device including an actuator that causes a piston to be operated by an electric motor functioning as a drive source.

In a case where the hydraulic brake device is employed, the pressure of the working fluid in the hydraulic cylinder represents the braking force. In this case, the controller may be configured to cause the brake device to perform the ABS operation based on the pressure of the working fluid in the hydraulic cylinder, in place of the braking force. In this configuration, the “decrease mode” and the “increase mode” described above may be referred to as a “pressure decrease mode” and a “pressure increase mode”, respectively. Further, a “hold mode”, a “steep increase mode”, and a “gradual increase mode” that will be later described may be referred to as a “pressure hold mode”, a “steep pressure increase mode”, and a “gradual pressure increase mode”, respectively. The “decrease mode”, the “increase mode”, the “steep increase mode”, the “gradual increase mode”, and the “hold mode” may be referred to as a “decrease process”, an “increase process”, a “steep increase process”, a “gradual increase process”, and a “hold process”, respectively. The “decrease mode”, the “increase mode”, the “steep increase mode”, the “gradual increase mode”, and the “hold mode” may be collectively referred to as an operation mode.

The controller described above may be constituted principally by a computer including a CPU, a ROM, a RAM, etc. The controller may further include drivers (drive circuits) of operating components of the brake device. In a case where the brake device is the hydraulic brake device, the drivers include those for driving valves to control the hydraulic pressure, for instance. In a case where the brake device is the electric brake device, the drivers include, for instance, a drive circuit of the electric motor functioning as a drive source.

It is most common to represent the condition of the road surface on which the vehicle travels by a road surface friction coefficient µ (hereinafter referred to as a “road surface µ” where appropriate). The controller may cause the brake device to perform the ABS operation based on the road surface µ.

The final target braking force described above may be determined to be the same value as the braking force at the start time point of the ABS operation. Based on the braking force at the start time point of the ABS operation and the road surface µ, the final target braking force may be determined such that the smaller the road surface µ, the smaller the final target braking force is than the braking force at the start time point of the ABS operation. The cycle time described above means a length of time from the start time point to the end time point of one ABS operation. Specifically, the cycle time means a length of time from a start time point of the decrease mode to an end time point of the increase mode.

For an efficient ABS operation, the increase mode may include a steep increase mode in which the braking force is increased with a steep increase gradient and a gradual increase mode executed subsequent to the steep increase mode to increase the braking force with a gradual increase gradient that is less steep than the steep increase gradient. Each of the steep increase mode and the gradual increase mode is the operation mode. In this case, a steep increase time duration, in which the steep increase mode is executed, is determined desirably based on the condition of the road surface on which the vehicle travels. Further, a switching braking force, which is the braking force when the operation mode is switched from the steep increase mode to the gradual increase mode, may be determined to be the braking force with a set ratio with respect to the final target braking force, and the steep increase gradient may be determined based on the steep increase time duration and a difference between the braking force at a start time point of the steep increase mode and the switching braking force. In other words, the switching braking force is obtained by multiplying the final target braking force by the set ratio.

A reference gradual increase gradient, which is a reference of the gradual increase gradient, may be determined based on (a) a length of time from a start time point of the gradual increase mode to a scheduled end time point of the ABS operation that is determined based on the cycle time and (b) a difference between the braking force at the start time point of the gradual increase mode and the final target braking force. In view of the fact that the slip ratio of the wheel is improved relatively greatly in the gradual increase mode, the reference gradual increase gradient may be corrected based on the slip ratio of the wheel to determine the gradual increase gradient. In a case where the gradual increase gradient is thus determined, the gradual increase mode may be ended when the braking force reaches the final target braking force in the gradual increase mode even if the cycle time does not elapse, in order to end the ABS operation early.

The ABS operation may include, as the operation mode, a hold mode in which the braking force is held constant. The hold mode is executed between the decrease mode and the increase mode. In this case, the operation mode may be switched from the decrease mode to the hold mode when deceleration for rotation of the wheel becomes not greater than set deceleration and may be switched from the hold mode to the increase mode when acceleration for rotation of the wheel becomes not less than set acceleration. Here, the deceleration for the rotation of the wheel and the acceleration for the rotation of the wheel may be understood as a unified concept of acceleration/deceleration for the rotation of the wheel (hereinafter referred to as “wheel acceleration/deceleration” where appropriate). The wheel acceleration/deceleration takes a positive value when the rotational speed of the wheel is increasing and takes a negative value when the rotational speed of the wheel is decreasing. In a case where the wheel acceleration/deceleration is employed, the “set deceleration” described above is desirably set to the wheel acceleration/deceleration that is a negative value close to 0 (hereinafter referred to as “hold-mode-switching wheel acceleration/deceleration” where appropriate). When the wheel acceleration/deceleration becomes not less than the hold-mode-switching wheel acceleration/deceleration, the operation mode is switched from the decrease mode to the hold mode. Similarly, the “set acceleration” described above is desirably set to the wheel acceleration/deceleration that is a positive value close to 0 (hereinafter referred to as “increase-mode-switching wheel acceleration/deceleration” where appropriate).

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a view illustrating a hardware configuration of a brake system for a vehicle according to one embodiment of the present disclosure;

FIG. 2 is a graph illustrating a change in a rotational speed of a wheel when a braking force is applied to the vehicle and an overview of an ABS operation performed on the wheel in accordance with the change;

FIG. 3 is a graph illustrating a change in the braking force in accordance with a lapse of time in the ABS operation;

FIG. 4A is a map for determining a cycle time that is a parameter in the ABS operation;

FIG. 4B is a map for determining a pressure decrease gradient that is a parameter in the ABS operation;

FIG. 4C is a map for determining a steep pressure increase time duration that is a parameter in the ABS operation;

FIG. 4D is a map for determining a coefficient for correcting a gradual pressure increase gradient that is a parameter in the ABS operation;

FIG. 5 is a flowchart representing an ABS control program executed in the brake system according to the embodiment;

FIG. 6 is a flowchart representing a pressure decrease mode subroutine of the ABS control program;

FIG. 7 is a flowchart representing a pressure hold mode subroutine of the ABS control program; and

FIG. 8 illustrates a flow chart representing a steep pressure increase mode subroutine and a flowchart representing a gradual pressure increase mode subroutine of the ABS control program.

### DETAILED DESCRIPTION

Referring to the drawings, there will be described in detail a brake system according to one embodiment of the present disclosure. It is to be understood that the present disclosure is not limited to the details of the following embodiment but may be embodied based on the forms described in Various Forms and may be changed and modified based on the knowledge of those skilled in the art.

### A. Hardware Configuration of Brake System

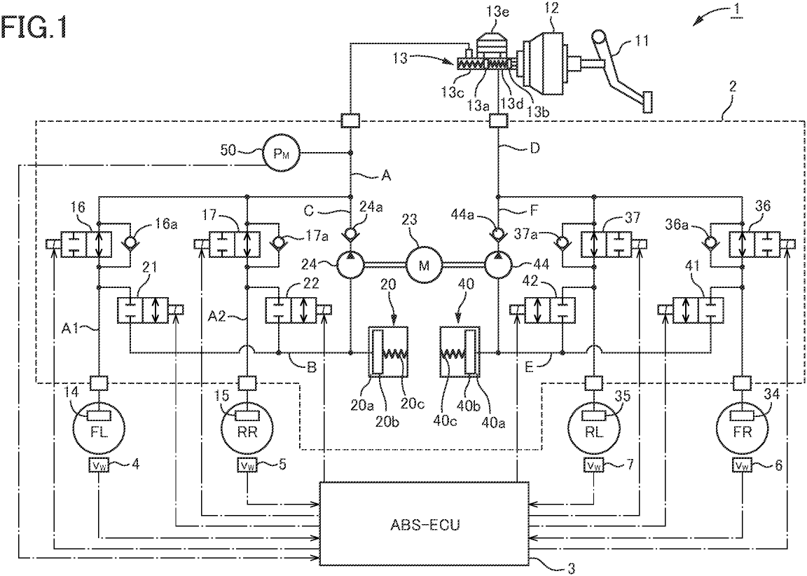

As illustrated in a hydraulic circuit diagram of FIG. 1, the brake system according to the present embodiment includes a hydraulic brake device 1 (hereinafter simply referred to as “brake device 1” where appropriate) as a main constituent element. For enabling the brake device 1 to perform an ABS operation, the brake device 1 includes an ABS actuator 2 (hereinafter simply referred to as “actuator 2” where appropriate). The actuator 2 is controlled by an ABS electronic control unit 3 (hereinafter referred to as “ABS-ECU 3” where appropriate), which is a controller of the brake system.

The brake device 1 includes, in addition to the actuator 2, a brake pedal 11, which is a brake operation member, a negative-pressure booster 12, which is a booster device, a master cylinder 13, and four wheel brakes 14, 15, 34, 35 provided respectively for four wheels, i.e., a front left wheel FL, a rear right wheel RR, a front right wheel FR, and a rear left wheel RL. Each of the wheel brakes 14, 15, 34, 35 is a disc brake having a known ordinary structure. That is, each of the wheel brakes 14, 15, 34, 35 includes a disc rotor that is a rotary member configured to rotate with the corresponding wheel, brake pads each as a friction member, and a wheel cylinder functioning as a hydraulic cylinder to which a working fluid is supplied for pressing the brake pads against the disc rotor. The ABS actuator 2, the brake pedal 11, the negative-pressure booster 12, and the master cylinder 13 function as a working-fluid supply device configured to supply the working fluid to each wheel cylinder.

When a driver depresses the brake pedal 11, a pedal force with which the brake pedal 11 is depressed is boosted by the negative-pressure booster 12 so that pressurizing pistons 13a, 13b disposed in the master cylinder 13 are pressed. This causes fluid pressures having mutually the same level to be generated in respective pressurizing chambers 13c, 13d defined in the master cylinder 13. The fluid pressure generated in the pressurizing chambers 13c, 13d will be hereinafter referred to as a “master pressure P_{M}” where appropriate. A reservoir 13e is attached to the master cylinder 13 so as to communicate with the pressurizing chambers 13c, 13d. The reservoir 13e has a function of supplying the working fluid to the master cylinder 13 and a function of storing an excess of the working fluid in the master cylinder 13.

The master pressure P_{M} generated in the master cylinder 13 is introduced, via the ABS actuator 2, into the wheel cylinder of each wheel brake 14, 15, 34, 35. The ABS actuator 2 includes a first system for applying a braking force to the front left wheel FL and the rear right wheel RR and a second system for applying a braking force to the front right wheel FR and the rear left wheel RL. The two systems are identical in configuration.

The first system of the ABS actuator 2 includes a main fluid passage A through which the master pressure P_{M} is introduced into the wheel cylinder of the wheel brake 14 provided for the front left wheel FL and the wheel cylinder of the wheel brake 15 provided for the rear right wheel RR. There is generated, in each of those wheel cylinders, a hydraulic pressure (hereinafter referred to as a “wheel cylinder pressure P_{W}” where appropriate) via the main fluid passage A. Specifically, the main fluid passage A branches off to two fluid passages A1, A2. The fluid passage A1 is connected to the wheel cylinder of the wheel brake 14, and the fluid passage A2 is connected to the wheel cylinder of the wheel brake 15.

The fluid passages A1, A2 are respectively provided with pressure increase valves 16, 17 for increasing the wheel cylinder pressure P_{W}. Each of the pressure increase valves 16, 17 is a normally-opened open/close valve configured to be placed in a valve open state when not energized and in a valve closed state when energized. The pressure increase valves 16, 17 are operable according to a pulse width modulation (PWM) method. Specifically, the pressure increase valves 16, 17 are duty-operated by changing a duty ratio, which is a ratio between an energized time and a non-energized time, so that the amount of the working fluid passing therethrough per unit time, i.e., a passing speed, can be changed. In other words, the pressure increase valves 16, 17 can change an increase gradient of the wheel cylinder pressure P_{W}, i.e., a pressure increase gradient.

The pressure increase valves 16, 17 are respectively provided with check valves 16a, 17a. When the driver performs a return operation of the brake pedal 11 in the ABS operation of the brake device 1 in a state in which the pressure increase valves 16, 17 are closed, the check valves 16a, 17a decrease the wheel cylinder pressure P_{W} in the corresponding wheel brakes 14, 15 in accordance with the return operation.

The first system includes a reservoir 20. Pressure decrease valves 21, 22 are disposed in a discharge passage B that connects the reservoir 20 and portions of the fluid passages A1, A2 between the pressure increase valves 16, 17 and the wheel brakes 14, 15. Each of the pressure decrease valves 21, 22 is a normally-closed open/close valve configured to be placed in a valve closed state when not energized. Like the pressure increase valves 16, 17, the pressure decrease valves 21, 22 are operable according to the PWM method. The pressure decrease valves 21, 22 are duty-operated, so that the amount of the working fluid passing therethrough per unit time, i.e., a passing speed, can be changed. In other words, the pressure decrease valves 21, 22 can change a decrease gradient of the wheel cylinder pressure P_{W}, i.e., a pressure decrease gradient.

The first system further includes a return passage C connecting the reservoir 20 and the main fluid passage A. A pump 24 is provided in the return passage C for pumping up the working fluid from the reservoir 20 to a portion of the main fluid passage A located upstream of the pressure increase valves 16, 17 closer to the master cylinder 13. The pump 24 is driven by a motor 23 common to the first system and the second system. A check valve 24a is disposed on an ejection side of the pump 24 for preventing a backflow of the working fluid via the pump 24. The motor 23 is operated to drive the pump 24 at a start time point of the ABS operation. The motor 23 is stopped operating so as to stop driving the pump 24 at an end time point of the ABS operation.

The reservoir 20 includes a reservoir chamber 20a, a piston 20b that defines the reservoir chamber 20a, and a spring 20c that urges the piston 20b. The working fluid discharged from the wheel cylinders of the wheel brakes 14, 15 is stored in the reservoir chamber 20a to a predetermined amount.

The first system of the ABS actuator 2 has been described. Like the first system, the second system includes a main fluid passage D, a discharge passage E, and a return passage F. The second system further includes pressure increase valves 36, 37, check valves 36a, 37a, a reservoir 40 and constituent elements 40a-40c thereof, pressure decrease valves 41, 42, a pump 44, and a check valve 44a, each for controlling the wheel cylinder pressure P_{W} of the wheel brakes 34, 35 provided respectively for the front right wheel FR and the rear left wheel RL.

The ABS actuator 2 further includes a master pressure sensor 50 for detecting the master pressure P_{M}. The wheels FL, RR, FR, RL are respectively provided with wheel speed sensors 4, 5, 6, 7 each for detecting a rotational speed vw of the corresponding wheel (hereinafter referred to as “wheel speed vw” where appropriate).

The ABS-ECU 3, which is a controller for the ABS operation performed by the brake device 1, includes a computer constituted by a CPU, a ROM, a RAM, an input/output interface, and a bus connecting those elements and drivers (drive circuits) configured to operate based on commands from the computer and to drive the constituent elements of the brake device 1. Specifically, the ABS-ECU 3 includes a driver of the motor 23 for driving the pumps 24, 44 and drivers for opening/closing and duty-operating the pressure increase valves 16, 17, 36, 37 and the pressure decrease valves 21, 22, 41, 42. The computer receives, via the input/output interface, a signal indicative of the master pressure P_{M} from the master pressure sensor 50 and a signal indicative of each wheel speed vw from the corresponding wheel speed sensor 4, 5, 6, 7.

### B. Description of ABS Control

### I) Overview of ABS Control

The ABS control is for preventing locking of the wheel when the braking force is applied to the wheel. For performing the ABS control, the computer has a function of detecting a traveling speed v of the vehicle based on the wheel speeds vw of the respective wheels. (The traveling speed v of the vehicle hereinafter referred to as “vehicle speed v” where appropriate and may be referred to as “vehicle body speed v”.) The computer further has a function of detecting a slip ratio SLP of each wheel represented by the following expression:

$$\text{SLP=} \left(\text{v} \text{} - \text{} \text{r} \cdot {\text{v}}_{\text{w}}\right) / \text{v} \text{r} \text{. wheel effective radius}$$

The slip ratio SLP=1 indicates that the wheel completely locks. Moreover, the computer has a function of estimating, as a condition of a road surface on which the vehicle is traveling, a friction coefficient µ of the road surface, namely, a road surface µ, based on the slip ratio SLP of the wheel and the braking force for braking the wheel obtained based on the master pressure P_{M}. The technique of detecting the vehicle speed v and the slip ratio SLP and the technique of estimating the road surface friction coefficient µ are known in the art, a detained description of which is dispensed with.

The ABS control is performed individually for the four wheels. Thus, the following description about the ABS control will be made focusing on one of the four wheels that is not specified, and the reference signs of the constituent elements utilized in the description of the hardware configuration of the brake system are omitted.

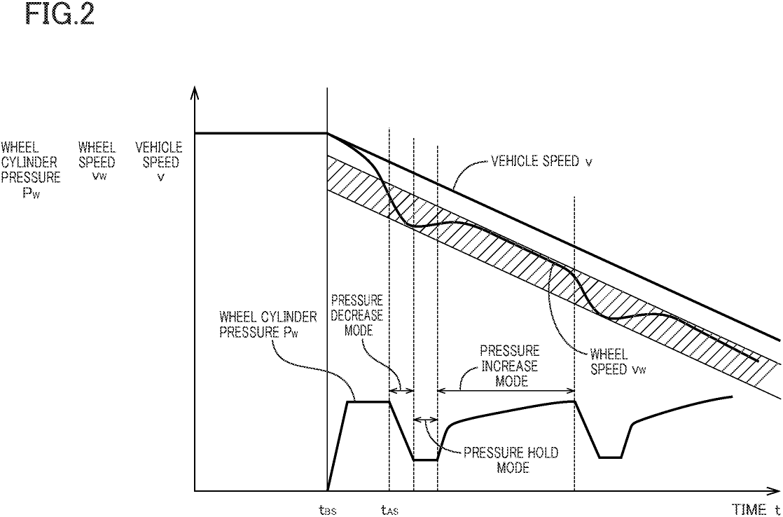

FIG. 2 is a graph illustrating a change in the vehicle speed v when the braking force is applied to the wheel, a change in the wheel speed vw, and a change in the wheel cylinder pressure P_{W} of the wheel brake provided for the wheel. In the graph, the wheel speed vw and the vehicle speed v are shown in the same dimension. In other words, the wheel speed vw is shown as a value obtained by multiplying the wheel speed v_{W} by the wheel effective radius r. The present brake system includes the hydraulic brake device 1, and the wheel cylinder pressure P_{W} represents the braking force applied to the wheel. Thus, the following description will be made utilizing the wheel cylinder pressure P_{W} in place of the braking force.

As illustrated in the graph of FIG. 2, when the driver starts performing an operation on the brake pedal at a time point t_{BS} to start a braking operation in a situation in which the vehicle is traveling at a given vehicle speed v, namely, when the braking force with a certain magnitude starts to be applied to the wheel, the vehicle speed v starts to decrease from the time point t_{BS}. In a case where the wheel does not slip, the wheel speed vw decreases in accordance with a decrease in the vehicle speed v. In a case where the wheel slips, on the other hand, the wheel speed vw greatly decreases, as apparent from the graph of FIG. 2. That is, the slip ratio SLP rises.

In the ABS control, as illustrated in the graph of FIG. 2, the controller causes the brake device to perform an ABS operation including, each as an operation mode, a decrease mode in which the braking force is decreased and an increase mode in which the braking force is increased to restore the decreased braking force, when the slip ratio SLP of the wheel exceeds a threshold SLP_{S} (hereinafter referred to as “ABS-operation start threshold slip ratio SLP_{S}” where appropriate), namely, from an ABS-operation start time point t_{AS}. In other words, the controller causes the brake device to perform the ABS operation including a pressure decrease mode to decrease the wheel cylinder pressure P_{W} and a pressure increase mode to increase the wheel cylinder pressure P_{W}. The ABS operation performed in the present brake system further includes, as another operation mode executed between the pressure decrease mode and the pressure increase mode, a pressure hold mode for holding the wheel cylinder pressure P_{W} constant. In other words, the pressure hold mode is a hold mode for holding the braking force constant, namely.

In the ABS control, the ABS operation is repeatedly performed in one brake operation as long as the slip ratio SLP is greater than the ABS-operation start threshold slip ratio SLP_{S}. In the one brake operation, the slip ratio SLP of the wheel is controlled to fall within a target slip ratio range indicated by hatching in the graph, thus preventing locking of the wheel.

### II) Details of ABS Operation

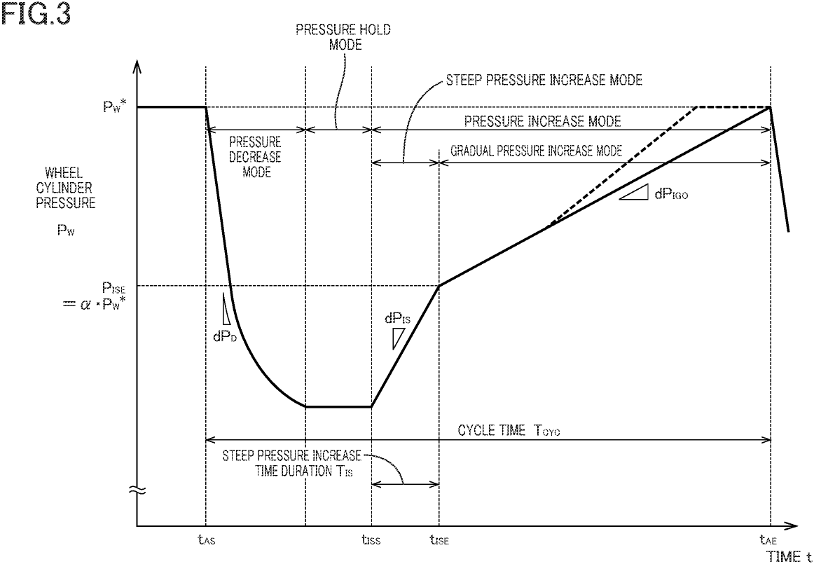

Referring next to a graph of FIG. 3, the ABS operation will be described in detail. The graph of FIG. 3 illustrates a change in the braking force with a lapse of time during the ABS operation, specifically, a change in the wheel cylinder pressure P_{W}. As described above, the ABS operation starts to be performed when the slip ratio SLP of the wheel exceeds the ABS-operation start threshold slip ratio SLP_{S}, namely, from the ABS-operation start time point t_{AS} in the graph.

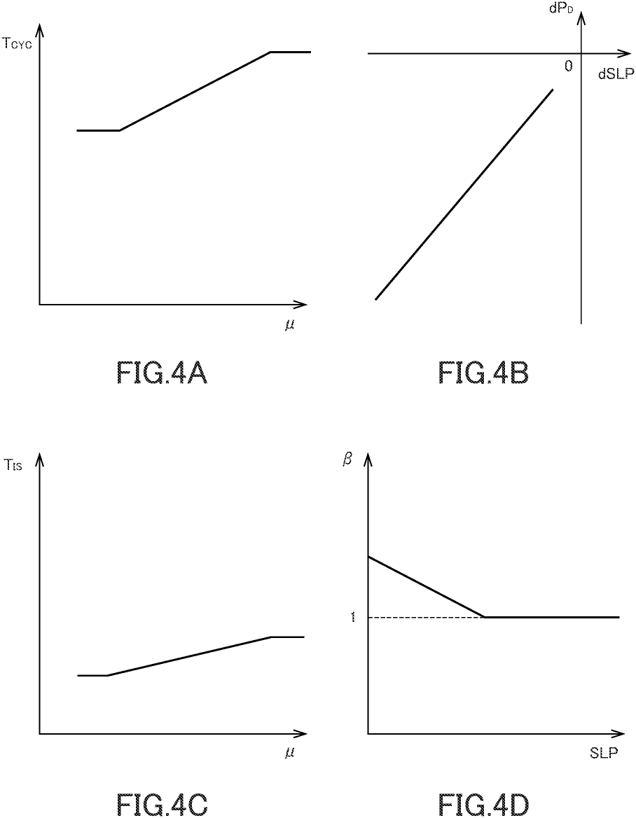

In starting the ABS operation, the ABS-ECU determines a cycle time T_{CYC}, which is a length of time in which the ABS operation is performed, namely, a length of time from the ABS-operation start time point t_{AS} to a scheduled end time point t_{AE} of the ABS operation. The ABS-ECU determines the cycle time T_{CYC} referring to a cycle time determination map illustrated in FIG. 4A. The map of FIG. 4A represents a relationship between the cycle time T_{CYC} and the road surface friction coefficient µ, which indicates the condition of the road surface on which the vehicle travels. According to this map, the cycle time T_{CYC} is determined such that the smaller the road surface friction coefficient µ, the shorter the cycle time T_{CYC}, for performing the ABS operation such that the more slippery the road surface, the more times the ABS operation with a shorter time is performed.

The present brake system does not include a wheel cylinder pressure sensor for detecting the wheel cylinder pressure P_{W}. The wheel cylinder pressure P_{W} is considered to be equal to the master pressure P_{M} when the ABS operation is not being performed. Thus, the ABS-ECU identifies the wheel cylinder pressure P_{W} at the ABS-operation start time point t_{AS} as the master pressure P_{M} at that time point. The ABS-ECU determines a final target braking force that is the braking force when the ABS operation is ended, namely, a target pressure P_{W}*at the end of the ABS operation that is the wheel cylinder pressure P_{W} when the ABS operation is ended (hereinafter referred to as an “ABS-operation end-time target pressure P_{W}*” where appropriate), based on the braking force at the ABS-operation start time point t_{AS}, namely, based on the wheel cylinder pressure P_{W} at the ABS-operation start time point t_{AS}. In the present brake system, the ABS-operation end-time target pressure P_{W}* and the wheel cylinder pressure P_{W} at the ABS-operation start time point t_{AS} are equal to each other.

In the ABS operation, the ABS-ECU initially executes the pressure decrease mode. In the pressure decrease mode, the ABS-ECU closes the pressure increase valve of the ABS actuator and causes the pressure decrease valve of the ABS actuator to be duty-operated. The ABS-ECU refers to a pressure decrease gradient determination map of FIG. 4B to determine the decrease gradient of the braking force in the pressure decrease mode, namely, a pressure decrease gradient dP_{D} of the wheel cylinder pressure P_{W}. Specifically, the ABS-ECU identifies a slip-ratio change rate dSLP, which is a rate of change of the slip ratio SLP, and determines the pressure decrease gradient dP_{D} such that the closer the slip-ratio change rate dSLP is to 0, the less steep the pressure decrease gradient dP_{D} is. The ABS-ECU causes the pressure decrease valve to be duty-operated based on the thus determined pressure decrease gradient dP_{D}. In the pressure decrease mode, each of the pressure decrease gradient dP_{D} and the slip-ratio change rate dSLP takes a negative value. The ABS-ECU estimates the wheel cylinder pressure P_{W} at all times in the pressure decrease mode based on the wheel cylinder pressure P_{W} at the ABS-operation start time point t_{AS}, a lapse of time from that time point, and the pressure decrease gradient dP_{D} determined as described above.

Based on the wheel speed v_{W} detected by the wheel speed sensor, the ABS-ECU identifies wheel acceleration/deceleration dvw, which is a rate of change of the wheel speed vw. In this respect, the wheel acceleration/deceleration dvw is wheel acceleration when positive while the wheel acceleration/deceleration dvw is wheel deceleration when negative. Though the wheel speed vw keeps decreasing in the pressure decrease mode, the rate of decrease becomes considerably low when the wheel speed vw decreases to a certain extent. Accordingly, the ABS-ECU ends the pressure decrease mode and switches the operation mode to the pressure hold mode when the decrease of the wheel speed can be regarded as having stopped, namely, when the wheel acceleration/deceleration dvw becomes equal to pressure-hold-mode-switching deceleration dv_{WM}, which is set to a negative value close to 0.

When switching to the pressure hold mode, the ABS-ECU closes the pressure decrease valve of the ABS actuator. Consequently, the wheel cylinder pressure P_{W} at that time point is maintained. In the pressure hold mode, the wheel speed stops decreasing and starts increasing. Accordingly, the ABS-ECU ends the pressure hold mode and switches the operation mode to the pressure increase mode when the increase of the wheel speed can be regarded as having started, namely, when the wheel acceleration/deceleration dvw becomes equal to pressure-increase-mode-switching acceleration dv_{WI}, which is set to a positive value close to 0.

In the pressure increase mode, the pressure increase valve of the ABS actuator is duty-operated in a state in which the pressure decrease valve of the ABS actuator is closed. For enabling the wheel cylinder pressure P_{W} to be efficiently and appropriately restored, the pressure increase mode of the ABS operation in the present brake system includes a steep pressure increase mode in which the pressure increase gradient of the wheel cylinder pressure P_{W} is set to a steep pressure increase gradient dP_{IS}, which is relatively steep, and a gradual pressure increase mode which is executed subsequent to the steep pressure increase mode and in which the pressure increase gradient of the wheel cylinder pressure P_{W} is set to a gradual pressure increase gradient dP_{IG}, which is relatively less steep. In other words, the increase mode of the ABS operation includes a steep increase mode in which the increase gradient of the braking force is set to a steep increase gradient, which is relatively steep, and a gradual increase mode in which the increase gradient of the braking force is set to a gradual increase gradient, which is relatively less steep.

Prior to execution of the steep pressure increase mode, the ABS-ECU of the brake system determines a steep pressure increase time duration T_{IS}, which is a length of time in which the steep pressure increase mode is executed, by referring to a steep pressure increase time duration determination map of FIG. 4C. The map of FIG. 4C represents a relationship between the steep pressure increase time duration T_{IS} and the road surface friction coefficient µ, which is the condition of the road surface on which the vehicle travels. According to this map, the steep pressure increase time duration T_{IS} is determined such that the smaller the road surface friction coefficient µ, the shorter the steep pressure increase time duration T_{IS}, for performing the ABS operation such that the more slippery the road surface, the more times the ABS operation with a shorter time is performed, as in the determination of the cycle time T_{CYC} described above. The ABS-ECU measures a length of time after the ABS operation has been started. The ABS-ECU identifies the current time point as a steep-pressure-increase start time point t_{IS} and adds the steep pressure increase time duration T_{IS} to the steep-pressure-increase start time point t_{ISS}, so as to determine a scheduled end time point t_{ISE} of the steep pressure increase, which is a time point at which the steep pressure increase mode should be ended.

The ABS-ECU determines a steep-pressure-increase end pressure P_{ISE}, which is the wheel cylinder pressure P_{W} that should be attained at an end time point of the steep pressure increase mode. Specifically, the steep-pressure-increase end pressure P_{ISE} is determined by multiplying the ABS-operation end-time target pressure P_{W}* by a steep-pressure-increase end pressure determination coefficient α. In this respect, the steep-pressure-increase end pressure determination coefficient α is set to about 0.6 in the present brake system. The ABS-ECU divides a difference between the steep-pressure-increase end pressure P_{ISE} and the wheel cylinder pressure P_{W} estimated at the start time point of the steep pressure increase mode, namely, estimated at an end time point of the pressure hold mode, by the steep pressure increase time duration T_{IS} to thereby determine the steep pressure increase gradient dP_{IS}, which is the pressure increase gradient of the wheel cylinder pressure P_{W} that should be attained in the steep pressure increase mode. This can be rephrased as follows in terms of the braking force. The ABS-ECU determines a switching braking force, which is the braking force when switching from the steep increase mode to the gradual increase mode, to be the braking force with a set ratio with respect to the final target braking force and determines the steep increase gradient based on the steep increase time duration and a difference between the braking force at the start time point of the steep increase mode and the switching braking force.

In the steep pressure increase mode, the ABS-ECU causes the pressure increase valve to be duty-operated based on the steep pressure increase gradient dP_{IS} determined as described above. Further, the ABS-ECU estimates the wheel cylinder pressure P_{W} at all times also in the steep pressure increase mode, as in the pressure decrease mode, based on a lapse of time after the steep pressure increase mode has been started and the determined steep pressure increase gradient dP_{IS}. When the time after the ABS operation has been started reaches the scheduled end time point t_{ISE} of the steep pressure increase, the ABS-ECU ends the steep pressure increase mode and switches the operation mode to the gradual pressure increase mode.

When switching to the gradual pressure increase mode, the ABS-ECU determines a reference gradual pressure increase gradient dP_{IG0}, which is a reference of the pressure increase gradient in the gradual pressure increase mode. Specifically, the ABS-ECU determines the reference gradual pressure increase gradient dP_{IG0} by dividing (a) a difference obtained by subtracting the wheel cylinder pressure P_{W} at the start time point of the gradual pressure increase mode from the ABS-operation end-time target pressure P_{W}* by (b) a difference obtained by subtracting, from the cycle time T_{CYC}, a length of time from the start time point of the ABS operation to the start time point of the gradual pressure increase mode. This can be rephrased in terms of the braking force as follows. The ABS-ECU determines a reference gradual increase gradient, which is a reference of the gradual increase gradient, based on: a length of time from the start time point of the gradual increase mode to the scheduled end time point of the ABS operation that is determined based on the cycle time T_{CYC}; and a difference between the braking force at the start time point of the gradual increase mode and the final target braking force.

In the gradual pressure increase mode, the ABS-ECU corrects the reference gradual pressure increase gradient dP_{IG0} to determine the gradual pressure increase gradient dP_{IG}, which is the pressure increase gradient in the gradual pressure increase mode. Specifically, the ABS-ECU multiplies the reference gradual pressure increase gradient dP_{IG0} by a gradual-pressure-increase-gradient correction coefficient β to thereby determine the gradual pressure increase gradient dP_{IG}. The ABS-ECU determines the gradual-pressure-increase-gradient correction coefficient β referring to a gradual-pressure-increase-gradient correction coefficient determination map of FIG. 4D. This map represents the gradual-pressure-increase-gradient correction coefficient β with respect to the slip ratio SLP. According to this map, the gradual-pressure-increase-gradient correction coefficient β is determined so as to be equal to 1 when the slip ratio SLP is high to a certain extent and so as to gradually become greater than 1 when the slip ratio SLP is lowered to a certain extent.

In the gradual pressure increase mode, the ABS-ECU causes the pressure increase valve to be duty-operated based on the gradual pressure increase gradient dP_{IG} determined as described above. When the slip ratio SLP is high to a certain extent, the wheel cylinder pressure P_{W} is increased along the reference gradual pressure increase gradient dP_{IG0}. When the slip ratio SLP is lowered to a certain extent in the midst of the gradual pressure increase mode, the wheel cylinder pressure P_{W} is increased along a gradient that is steeper than the reference gradual pressure increase gradient dP_{IG0}, as indicated by the dashed line in FIG. 3, for instance.

The ABS-ECU estimates the wheel cylinder pressure P_{W} at all times also in the gradual pressure increase mode, as in the steep pressure increase mode, based on a lapse of time after the gradual pressure increase mode has been started and the determined gradual pressure increase gradient dP_{IG}. The ABS-ECU ends the gradual pressure increase mode when a time that has elapsed from the ABS-operation start time point t_{AS} reaches the cycle time T_{CYC} or when the estimated wheel cylinder pressure P_{W} reaches the ABS-operation end-time target pressure P_{W}*. Thus, in a case where the slip ratio SLP remains high, the gradual pressure increase mode is ended when the time that has elapsed after the ABS-operation start time point t_{AS} reaches the cycle time T_{CYC}. In a case where the slip ratio SLP is lowered to a certain extent in the midst of the gradual pressure increase mode, the gradual pressure increase mode is ended before the cycle time T_{CYC} elapses. When the gradual pressure increase mode is ended, the pressure increase valve is closed.

The ABS operation has been described above. In the present brake system, the ABS-operation end-time target pressure P_{W}* is determined based on the wheel cylinder pressure P_{W} at the ABS-operation start time point t_{AS}, and the cycle time T_{CYC} is determined based on the road surface friction coefficient µ, which is the condition of the road surface on which the vehicle travels. The thus configured brake system ensures an appropriate ABS operation by a relatively simple process. Further, the steep pressure increase gradient dP_{IS} in the steep pressure increase mode is also determined based on the road surface friction coefficient µ. This is also effective for achieving an appropriate ABS operation by a relatively simple process.

### III) Flow of ABS Control

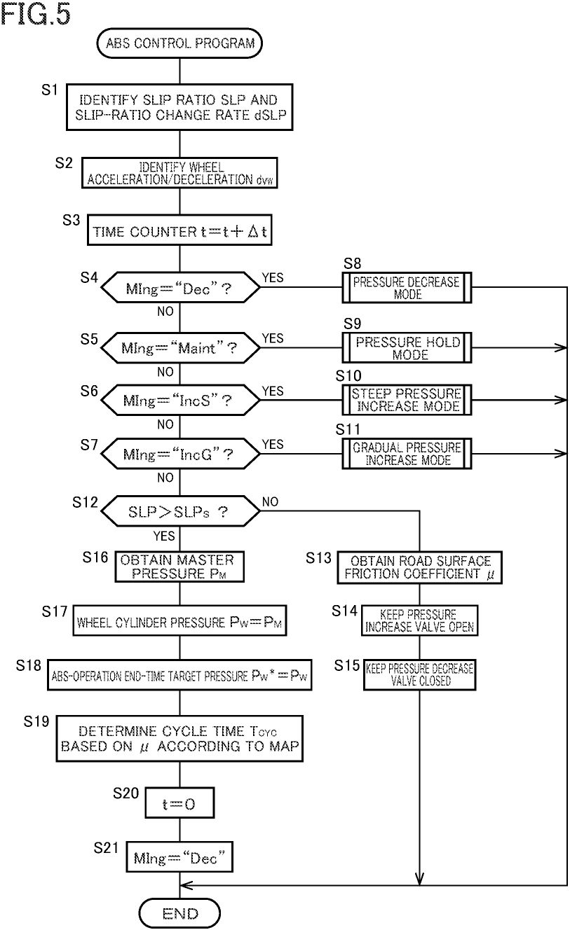

The computer of the ABS-ECU repeatedly executes an ABS control program represented by a flowchart of FIG. 5 at a relatively short time pitch Δt, e.g., several milliseconds, so that the ABS control described above is executed. Referring to the flowchart, there will be explained a flow of the processing in the ABS control.

In the processing according to the ABS control program, the slip ratio SLP of the wheel and the slip-ratio change rate dSLP are identified at Step 1. (Step 1 will be hereinafter abbreviated as “S1”. Other steps will be similarly abbreviated.) At S2, the wheel acceleration/deceleration dv_{W} is identified based on detection by the wheel speed sensor. At S3, a time counter t for measuring a time is incremented by the pitch Δt at which the program is executed.

For the ABS control, a mode indicator MIng is set for indicating which one of the modes described above should be executed or which one of the modes described above is currently being executed. When the ABS operation is not being performed, namely, in a normal mode, the mode indicator MIng is set to “Norm”. The mode indicator MIng is set to “Dec” in the pressure decrease mode, “Maint” in the pressure hold mode, “IncS” in the steep pressure increase mode, and “IncG” in the gradual pressure increase mode. At S4-S7, the value of the mode indicator MIng is judged. When the value of the mode indicator MIng is judged as “Dec” at S4, “Maint” at S5, “IncS” at S6, and “IncG” at S7, there are executed a pressure decrease mode subroutine at S8, a pressure hold mode subroutine at S9, a steep pressure increase mode subroutine at S10, and a gradual pressure increase mode subroutine at S11, respectively.

When the ABS operation is not being performed, it is determined at S12 whether the slip ratio SLP is greater than the ABS-operation start threshold slip ratio SLP_{S}. When the slip ratio SLP is less than the ABS-operation start threshold slip ratio SLP_{S}, the control flow proceeds to S13 to obtain the friction coefficient µ of the road surface on which the vehicle is traveling. At S14, the pressure increase valve is kept open. At S15, the pressure decrease valve is kept closed.

When it is determined at S12 that the slip ratio SLP is greater than the ABS-operation start threshold slip ratio SLP_{S}, the control flow proceeds to S16 and subsequent steps to start the ABS operation. Specifically, the master pressure P_{M} is obtained at S16 based on the detection by the master pressure sensor. At S17, the wheel cylinder pressure P_{W} at the current time point is regarded as the master pressure P_{M}. At S18, the ABS-operation end-time target pressure P_{W}* is set to the wheel cylinder pressure P_{W} at the current time point. At S19, the cycle time T_{CYC} of the ABS operation to be performed from now on is determined based on the obtained road surface friction coefficient µ according to the map of FIG. 4A. At S20, the time counter t is reset. At S21, the mode indicator MIng is set to “Dec” to execute the pressure decrease mode.

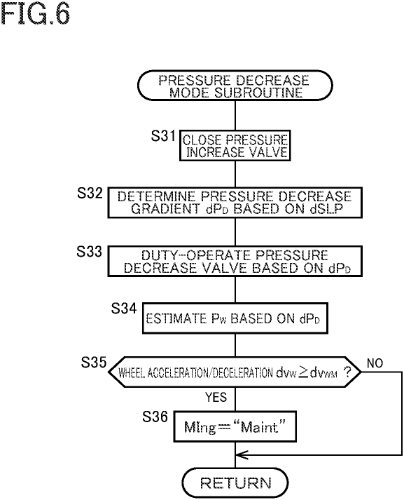

When it is determined at S4 that the mode indicator MIng is “Dec”, a pressure decrease mode subroutine represented by a flowchart of FIG. 6 is executed. In the processing according to the subroutine, the pressure increase valve is closed at S31. At S32, the pressure decrease gradient dP_{D} of the wheel cylinder pressure P_{W} in the pressure decrease mode is determined according to the map of FIG. 4B based on the slip-ratio change rate dSLP. At S33, the pressure decrease valve is duty-operated based on the determined pressure decrease gradient dP_{D}. At S34, the wheel cylinder pressure P_{W} at the current time point is estimated based on the pressure decrease gradient dP_{D}. At S35, it is determined whether the wheel acceleration/deceleration dvw has reached the pressure-hold-mode-switching deceleration dv_{WM}. When the wheel acceleration/deceleration dv_{W} does not yet reach the pressure-hold-mode-switching deceleration dv_{WM}, the processing according to the subroutine is ended. When the wheel acceleration/deceleration dv_{W} reaches the pressure-hold-mode-switching deceleration dv_{WM}, the mode indicator MIng is set to “Maint” at S36 to execute the pressure hold mode.

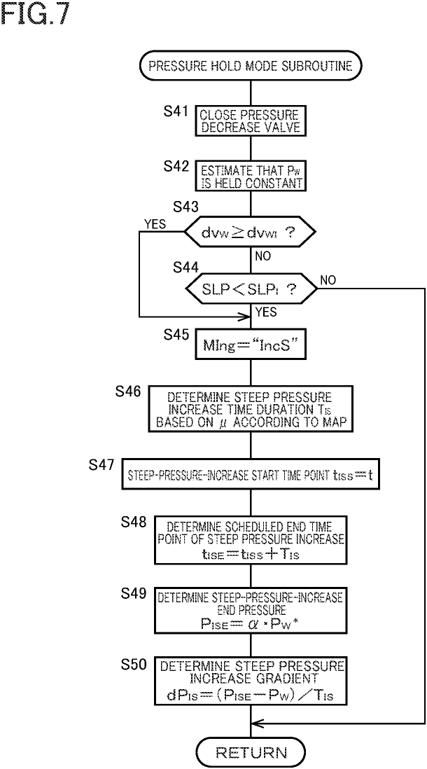

When it is determined at S5 that the mode indicator MIng is “Maint”, a pressure hold mode subroutine represented by a flowchart of FIG. 7 is executed. In the processing according to the subroutine, the pressure decrease valve is closed at S41. At S42, it is estimated that the wheel cylinder pressure P_{W} is held constant. At S43, it is determined whether the wheel acceleration/deceleration dv_{W} has reached the pressure-increase-mode-switching acceleration dv_{WI}. At S44, it is determined whether the slip ratio SLP has become lower than a pressure-increase-mode-switching threshold slip ratio SLP_{I}. When the wheel acceleration/deceleration dv_{W} does not yet reach the pressure-increase-mode-switching acceleration dv_{WI} and the slip ratio SLP is greater than or equal to the pressure-increase-mode-switching threshold slip ratio SLP_{I}, the subroutine is ended. When the wheel acceleration/deceleration dv_{W} reaches the pressure-increase-mode-switching acceleration dv_{WI} or when the slip ratio SLP is less than the pressure-increase-mode-switching threshold slip ratio SLP_{I}, S45 and subsequent steps are executed to switch the operation mode to the steep pressure increase mode.

Specifically, the mode indicator MIng is set to “IncS” at S45. At S46, the steep pressure increase time duration T_{IS} is determined based on the road surface friction coefficient µ according to the map of FIG. 4C. At S47, the current time point is identified as the steep-pressure-increase start time point t_{ISS}. At S48, the scheduled end time point t_{ISE} of the steep pressure increase is determined based on the steep pressure increase time duration T_{IS} and the steep-pressure-increase start time point t_{ISS}. At S49, the steep-pressure-increase end pressure P_{ISE} is determined by multiplying the determined ABS-operation end-time target pressure P_{W}* by the steep-pressure-increase end pressure determination coefficient α. At S50, the steep pressure increase gradient dP_{IS} that should be attained in the steep pressure increase mode is determined based on the steep-pressure-increase end pressure P_{ISE}, the wheel cylinder pressure P_{W} at the current time point, and the steep pressure increase time duration T_{IS}.

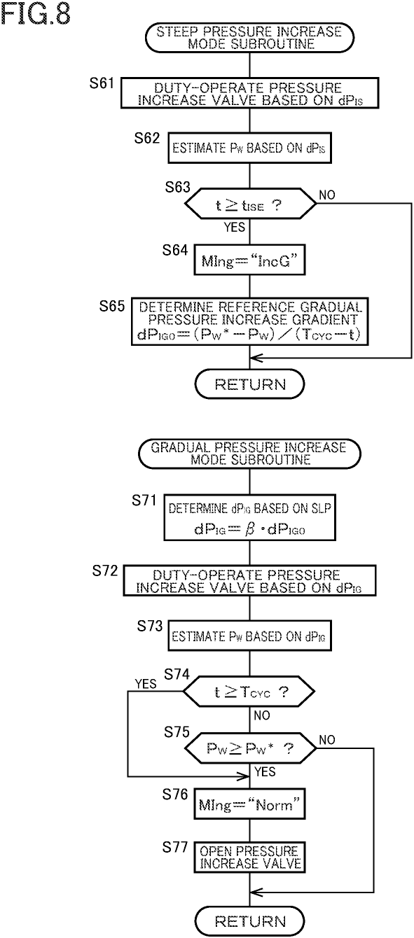

When it is determined at S6 that the mode indicator MIng is “IncS”, a steep pressure increase mode subroutine represented by a flowchart of FIG. 8 is executed. In the processing according to the subroutine, the pressure increase valve is duty-operated at S61 based on the determined steep pressure increase gradient dP_{IS}. At S62, the wheel cylinder pressure P_{W} at the current time point is estimated. At S63, it is determined whether the time t after the ABS operation has been started reaches the scheduled end time point t_{ISE} of the steep pressure increase. When the time t does not yet reach the scheduled end time point t_{ISE} of the steep pressure increase, the processing according to the subroutine is ended. When the time t reaches the scheduled end time point t_{ISE} of the steep pressure increase, the mode indicator MIng is set to “IncG” at S64 to switch the operation mode to the gradual pressure increase mode. At S65, the reference gradual pressure increase gradient dP_{IG0}, which is a reference of the gradual pressure increase gradient dP_{IG} that should be attained in the gradual pressure increase mode, is determined based on the ABS-operation end-time target pressure P_{W}*, the wheel cylinder pressure P_{W} at the current time point, the cycle time T_{CYC}, and the time t after the ABS operation has been started.

When it is determined at S7 that the mode indicator MIng is “IncG”, a gradual pressure increase mode subroutine represented by a flowchart of FIG. 8 is executed. In the processing according to the subroutine, the gradual pressure increase gradient dP_{IG} is determined at S71. Specifically, the reference gradual pressure increase gradient dP_{IG0} is corrected based on the gradual-pressure-increase-gradient correction coefficient β according to the map of FIG. 4D to thereby determine the gradual pressure increase gradient dP_{IG}. Based on the determined gradual pressure increase gradient dP_{IG}, the pressure increase valve is duty-operated at S72. At S73, the wheel cylinder pressure P_{W} is estimated.

At S74, it is determined whether the time after the ABS operation has been started reaches the cycle time T_{CYC}. At S75, it is determined whether the estimated wheel cylinder pressure P_{W} reaches the ABS-operation end-time target pressure P_{W}*. When the time after the ABS operation has been started does not yet reach the cycle time T_{CYC} and the wheel cylinder pressure P_{W} does not yet reach the ABS-operation end-time target pressure P_{W}*, the processing according to the subroutine is ended. When the time after the ABS operation has been started reaches the cycle time T_{CYC} or when the wheel cylinder pressure P_{W} reaches the ABS-operation end-time target pressure P_{W}*, the mode indicator MIng is set to “Norm” at S76 and the pressure increase valve is opened at S77 to end the ABS operation.

What is claimed is:

1. A brake system for a vehicle, comprising:
a brake device configured to apply a braking force to a wheel; and
a controller configured to cause the brake device to perform an ABS operation when a slip ratio of the wheel exceeds a threshold, the ABS operation including, each as an operation mode, a decrease mode in which the braking force is decreased and an increase mode in which the braking force is increased to restore the braking force after the decrease mode,
wherein the controller determines a final target braking force that should be attained at an end time point of the ABS operation based on the braking force at a start time point of the ABS operation and determines a cycle time of the ABS operation based on a condition of a road surface on which the vehicle travels, the cycle time being a length of time in which the ABS operation is performed.

2. The brake system according to claim 1, wherein the increase mode includes a steep increase mode in which the braking force is increased with a steep increase gradient and a gradual increase mode executed subsequent to the steep increase mode to increase the braking force with a gradual increase gradient that is less steep than the steep increase gradient, each of the steep increase mode and the gradual increase mode being the operation mode.

3. The brake system according to claim 2, wherein the controller is configured to determine, based on the condition of the road surface on which the vehicle travels, a steep increase time duration in which the steep increase mode is executed.

4. The brake system according to claim 3,
wherein the controller is configured to:
determine a switching braking force, which is the braking force when switching the operation mode from the steep increase mode to the gradual increase mode, to be the braking force with a set ratio with respect to the final target braking force; and
determine the steep increase gradient based on the steep increase time duration and a difference between the braking force at a start time point of the steep increase mode and the switching braking force.

5. The braking force according to claim 2,
wherein the controller is configured to:
determine a reference gradual increase gradient, which is a reference of the gradual increase gradient, based on (a) a length of time from a start time point of the gradual increase mode to a scheduled end time point of the ABS operation that is determined based on the cycle time and (b) a difference between the braking force at the start time point of the gradual increase mode and the final target braking force; and
increase the braking force in the gradual increase mode based on the reference gradual increase gradient.

6. The brake system according to claim 5, wherein the controller is configured to correct the reference gradual increase gradient based on the slip ratio of the wheel to determine the gradual increase gradient.

7. The brake system according to claim 6, wherein the controller is configured to end the gradual increase mode when the braking force reaches the final target braking force in the gradual increase mode even if the cycle time does not elapse.

8. The brake system according to claim 1,
wherein the ABS operation includes a hold mode in which the braking force is held constant, the hold mode being executed between the decrease mode and the increase mode, and
wherein the controller switches the operation mode from the decrease mode to the hold mode when deceleration for rotation of the wheel becomes not greater than set deceleration and switches the operation mode from the hold mode to the increase mode when acceleration for rotation of the wheel becomes not less than set acceleration.

9. The brake system according to claim 1, wherein the controller is configured to cause the brake device to perform the ABS operation based on a road surface friction coefficient that is the condition of the road surface on which the vehicle travels.

10. The brake system according to claim 1,
wherein the brake device includes a rotary member configured to rotate with the wheel, a friction member configured to be pressed against the rotary member, a hydraulic cylinder configured to be operated to press the friction member against the rotary member, and a working-fluid supply device configured to supply a working fluid to the hydraulic cylinder,
wherein a pressure of the working fluid in the hydraulic cylinder represents the braking force, and
wherein the controller is configured to cause the brake device to perform the ABS operation based on the pressure of the working fluid in the hydraulic pressure, in place of the braking force.
